(19) United States
(12) Patent Application Publication
(10) Pub. No.: US 2020/0214408 A1
(43) Pub. Date: Jul. 9, 2020

(54) TERMINAL HOLDER AND TERMINAL CASE

(71) Applicant: Woong Soo Shin, Gyeonggi-do (KR)

(72) Inventor: Woong Soo SHIN, Suwon-si (KR)

(21) Appl. No.: 16/633,542

(22) PCT Filed: Jul. 23, 2018
(86) PCT No.: PCT/KR2018/008263

§ 371 Date: Jan. 23, 2020

(30) Foreign Application Priority Data
Jul. 26, 2017 (KR) 10-2017-0094634

(51) Int. Cl. A45C 11/00; F16M 13/00; H04M 1/04

(52) U.S. Cl. CPC A45C 11/00; F16M 13/005; A45C 2011/003; A45C 2200/15; A45C 2011/002; H04M 1/04

(57) ABSTRACT

A terminal holder and a terminal case are disclosed. A terminal holder according to an embodiment may comprise: a holding plate which can be attached to a terminal; a fixing part which is disposed in the holding plate; and a support plate which is selectively connected to the fixing part and supports the holding plate on the ground in a state where the support plate is connected to the fixing part.

### TECHNICAL FIELD

The present invention relates to a terminal holder and a terminal case.

### BACKGROUND ART

A mobile phone holder can be used to place the mobile phone at a specific place or to hold the mobile phone at an angle relative to the ground. For example, a mobile phone holder for vehicles may be attached to a dashboard or windshield so that a user can see the mobile phone screen while driving. Alternatively, a phone holder for desks can be used to place a phone at a certain angle relative to a desk so that a user can easily look at a screen of the phone.

With regard to this, Korean Patent No. 2004-0096686 discloses a holder for fixing a mobile phone, the holder including a pressing member, and Korean Patent No. 2013-0021163 discloses a mobile phone holder for mounting mobile phones of various sizes or shapes.

### DISCLOSURE

### Technical Problem

Therefore, the present invention has been made in view of the above problems, and it is one object of the present invention to provide a terminal holder and terminal case, sizes of which may be minimized when not in use.

It is another object of the present invention to provide a terminal holder and terminal case enabling mounting of a terminal on the ground through a simple operation.

It is yet another object of the present invention to provide a terminal holder that may be used regardless of the type or size of a terminal.

### Technical Solution

In accordance with an aspect of the present invention, the above and other objects can be accomplished by the provision of a terminal holder, including: a holding plate configured to be attachable to a terminal; and a fixation part provided in the holding plate; and a support plate selectively connected to the fixation part and configured to support the holding plate with respect to the ground in a state of being connected to the fixation part.

In an aspect of the present invention, the fixation part may include an accommodation groove recessively formed at one surface of the holding plate to accommodate at least a portion of the support plate.

In an aspect of the present invention, one end of the support plate may be inserted into the accommodation groove.

In an aspect of the present invention, the terminal holder may further include a connection part for connecting the holding plate and the support plate to each other and helping maintain a connection state of the support plate to the accommodation groove.

In an aspect of the present invention, the connection part may include an elastic body for providing elastic force to pull the other side of the support plate in a direction of the holding plate in a state in which one end of the support plate is inserted into the accommodation groove.

In an aspect of the present invention, the support plate may include a protrusion provided at one surface thereof to be connected to one side of the elastic body.

In an aspect of the present invention, the protrusion may include an indentation formed to be concave inward, and a portion of the elastic body may be wound around the indentation.

In an aspect of the present invention, the support plate may be rotatable with respect to the elastic body to adjust a support angle to the holding plate.

In an aspect of the present invention, the holding plate may include an elastic body-fastening part for fastening the elastic body, wherein the elastic body-fastening part includes a through groove configured to penetrate from one surface of the holding plate to the other surface thereof; an elastic body-fastening groove formed at the other surface of the holding plate to accommodate another end of the elastic body inserted in the through groove; and a release prevention protrusion formed at the elastic body-fastening groove to prevent the other side of the elastic body from being released.

In an aspect of the present invention, one end of the support plate may be fitted into the accommodation groove.

In an aspect of the present invention, the accommodation groove may be slantly recessed such that the support plate is inclined with respect to the holding plate in a state in which the support plate is inserted into the accommodation groove.

In an aspect of the present invention, the support plate may include an engagement protrusion formed at one end thereof, and the fixation part may further include an engagement groove formed to be engaged with the engagement protrusion in a state in which the end of the support plate is inserted into the accommodation groove.

In an aspect of the present invention, the fixation part further includes a hinge which may be disposed in the accommodation groove and into which one end of the support plate is inserted, wherein the hinge is rotatable in the accommodation groove such that a connection angle of the support plate with respect to the holding plate is adjustable.

In an aspect of the present invention, the terminal holder may further include a magnet body provided in the accommodation groove to maintain a connection state between the fixation part and the support plate.

In an aspect of the present invention, the holding plate may include a plurality of an accommodation groove, and a mounting angle of the holding plate with respect to the ground may be adjusted according to a state of the support plate inserted into one of the accommodation grooves.

In an aspect of the present invention, the terminal holder may further include a fastening part for fastening the support plate to the holding plate in a state in which the support plate does not support the holding plate.

In an aspect of the present invention, the fastening part may include a fastening groove inwardly, recessively formed at the holding plate to correspond a size of the support plate.

In an aspect of the present invention, the fastening part may further include a pressing groove slantly recessed on one side of the fastening groove, and a fastened state between the holding plate and the support plate may be released when the pressing groove is pressed in a state in which the support plate is accommodated in the fastening groove.

In an aspect of the present invention, the fastening part may further include a release groove extended from one side of the fastening groove such that a gap is generated between the support plate and the fixation plate in a state in which the support plate is accommodated in the fastening groove.

In an aspect of the present invention, the terminal holder may further include a magnet body attached to the support plate or the fixation plate and configured to help maintain a fastened state of the support plate to the holding plate.

In an aspect of the present invention, the terminal holder may further include a magnetic plate included in the support plate or the fixation plate to be disposed on one side of the magnet body.

In accordance with another aspect of the present invention, there is provided a terminal case, including: a terminal cover for covering at least a portion of a terminal; a support plate for supporting the terminal cover with respect to the ground; a connection part for connecting the terminal cover and the support plate to each other; and a fixation part formed one side of the terminal cover and configured to accommodate a portion of the support plate to maintain a state of the support plate supporting the terminal cover.

In an aspect of the present invention, the terminal cover may include a support plate-accommodating part for fastening the support plate, wherein the support plate-accommodating part is recessed inwardly by a size corresponding to the support plate.

In an aspect of the present invention, the terminal case may further include a magnet body for helping maintain a connection state and fastening state between the terminal cover and the support plate-accommodating part.

### Advantageous Effects

As apparent from the above description, a terminal holder and terminal case according to an embodiment of the present invention can minimize the sizes thereof when not in use.

A terminal holder and terminal case according to an embodiment of the present invention can mount a terminal on the ground through a simple operation.

A terminal holder and terminal case according to an embodiment of the present invention can be used regardless of the type or size of a terminal.

It will be understood that technical effects of the terminal holder and the terminal case according to an embodiment of the present invention are not limited to those referred above and other non-referred technical effects will be clearly understood by those skilled in the art from disclosures below.

### DESCRIPTION OF DRAWINGS

The following drawings, which are attached to this specification, are only provided as preferred embodiments of the present invention and serve to further understand the technical spirit of the present invention together with the detailed description thereof. Accordingly, the scope of the present invention should not be construed as limited to the particulars described in the drawings.

FIG. 1 illustrates a state diagram of use of a terminal holder according to an embodiment of the present invention.

FIG. 2 illustrates a perspective view of a terminal holder according to an embodiment of the present invention.

FIG. 3 illustrates a plan view of a terminal holder according to an embodiment of the present invention.

FIG. 4 illustrates a sectional view of a terminal holder according to an embodiment of the present invention taken along line A-A of FIG. 3.

FIG. 5 is a view illustrating a fixation part according to an embodiment of the present invention in which portion B of FIG. 4 is enlarged.

FIG. 6 is a view illustrating a fixation part according to an embodiment of the present invention.

FIG. 7 is a view illustrating a fixation part according to an embodiment of the present invention.

FIG. 8 is a view illustrating a fixation part including a hinge part according to an embodiment of the present invention.

FIG. 9 is a view illustrating a fixation part including a hinge part according to an embodiment of the present invention.

FIG. 10 is a view illustrating a fixation part including a hinge part according to an embodiment of the present invention.

FIG. 11 is a view illustrating a fixation part according to an embodiment of the present invention.

FIG. 12 is a view illustrating a fixation part according to an embodiment of the present invention.

FIG. 13 is a view illustrating a connection part according to an embodiment of the present invention.

FIG. 14 is a view illustrating an elastic body-fastening part of a terminal holder according to an embodiment of the present invention.

FIG. 15 is a view illustrating a fastened state of a support plate and fixation plate of a terminal holder according to an embodiment of the present invention.

FIG. 16 illustrates a side sectional view of a terminal holder including a pressing groove according to an embodiment of the present invention.

FIG. 17 illustrates a perspective view of a terminal holder including a magnet body according to an embodiment of the present invention.

FIG. 18 illustrates a top view of a fixation plate including a magnet body according to an embodiment of the present invention.

FIG. 19 illustrates a sectional view of a fixation plate taken along line A-A of FIG. 18.

FIG. 20 illustrates a perspective view of a terminal holder including a magnet body according to an embodiment of the present invention.

FIG. 21 is a view illustrating a terminal holder including a magnet body according to an embodiment of the present invention.

FIG. 22 illustrates a state diagram of use of a terminal holder according to an embodiment of the present invention.

FIG. 23 illustrates a perspective view of a terminal case according to an embodiment of the present invention.

FIG. 24 illustrates a side view of a terminal case according to an embodiment of the present invention.

### BEST MODE

Hereinafter, exemplary embodiments will be described in detail with reference to the accompanying drawings. In adding reference numerals to components of each drawing, it should be noted that the same reference numerals are assigned to the same elements as much as possible, even though they are shown in different drawings. In addition, in describing an embodiment, when it is determined that the detailed description of related known configuration or function interferes with the understanding of the embodiment, the detailed description thereof will be omitted.

In addition, in describing components of embodiments, terms such as first, second, A, B, (a), and (b) may be used. These terms are only for distinguishing the components from other components, and the nature, order or sequence of the components are not limited by the terms. It should be understood that, when a component is described as being “connected”, “coupled” or “connected” to another component, the component may be directly coupled or connected to that other component, and another component may be “connected”, “coupled” or “access” between the components.

Components including the same functions as components included in any one embodiment will be described using the same names in other embodiments. Unless stated to the contrary, the description in any one embodiment may be applied to other embodiments, and detailed descriptions thereof will be omitted when overlapped.

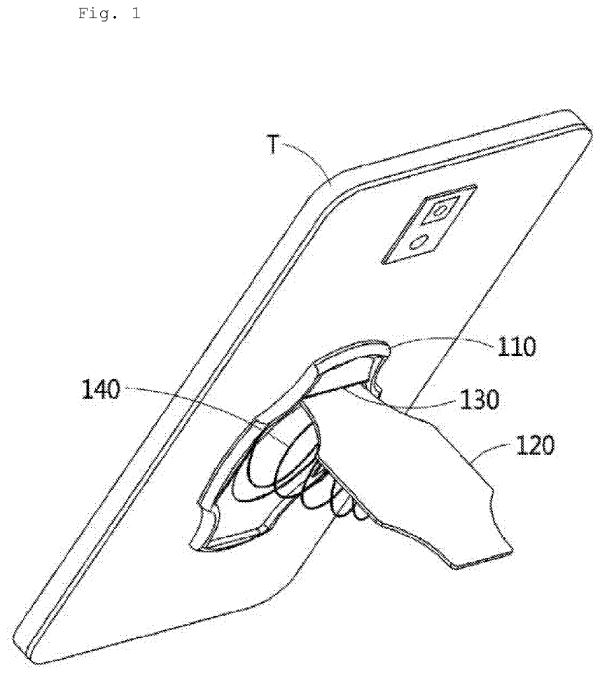

FIG. 1 illustrates a state diagram of use of a terminal holder according to an embodiment of the present invention.

Referring to FIG. 1, a terminal holder 1 according to an embodiment of the present invention may be attached to a rear surface of a terminal T, and enables the terminal T to be mounted on the ground such that a user sees a front surface of the terminal T. For example, the terminal holder 1 may mount the terminal T be inclined at a predetermined angle with respect to the ground, thus assisting a user in comfortably viewing a screen of the terminal T. Examples of the terminal T may include a portable terminal, a smartphone, a tablet, a device for language learning, an e-book, and the like. The terminal holder 1 may include a fixation plate 110, a support plate 120, a fixation part 130, and a connection part 140.

The fixation plate 110 may be attached to the terminal T. In addition, the fixation plate 110 may be attached to a case for covering the terminal T. For example, one side of the fixation plate 110 may be provided with an adhesive sheet (not shown). A fastener that can be used repeatedly may be used as the adhesive sheet. In addition, the fixation plate 110 may include an adsorption plate (not shown) that is fixed to the terminal T by adsorption force. However, this is only provided as one embodiment, and the type of the fixation plate 110 is not limited thereto. The fixation plate 110 may include various components that can be attached to the terminal T. As a result, the terminal holder 1 may be used regardless of the type or size of the terminal T.

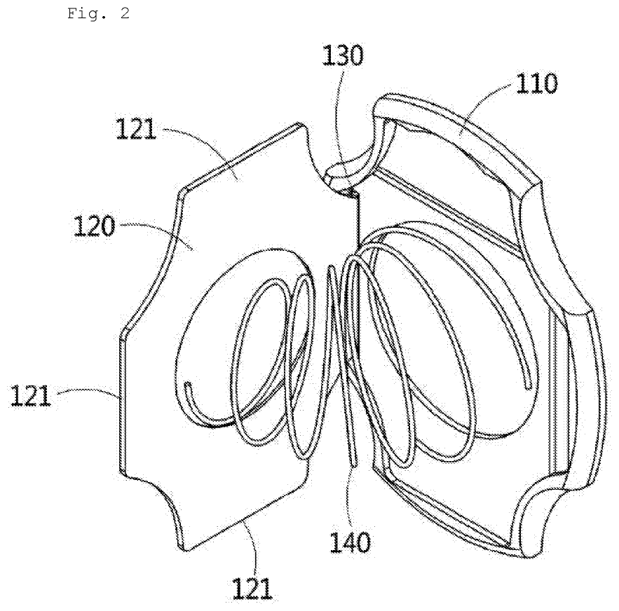

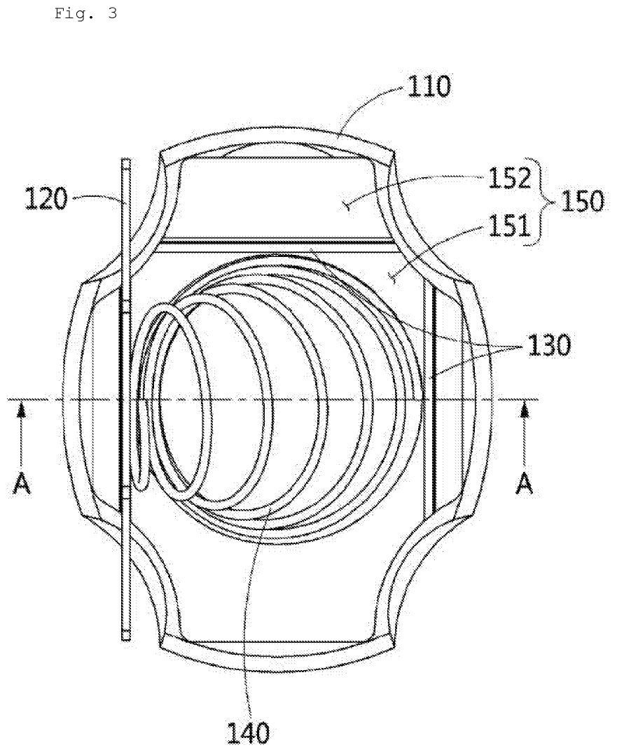

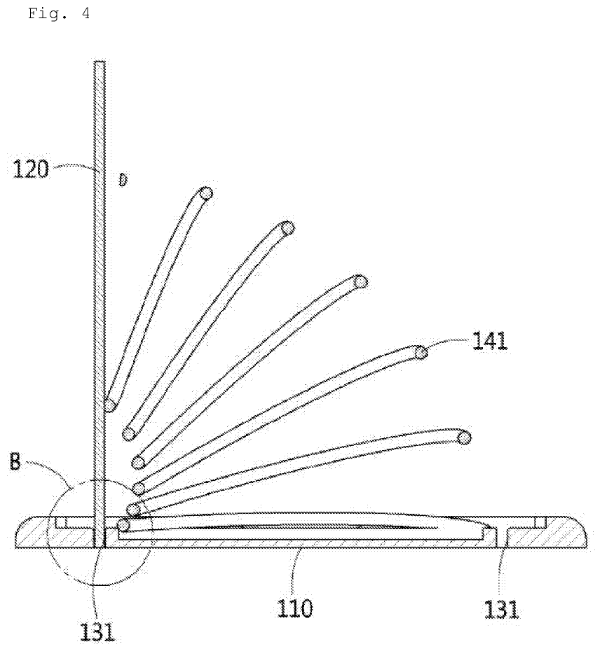

FIG. 2 illustrates a perspective view of a terminal holder according to an embodiment of the present invention, FIG. 3 illustrates a plan view of a terminal holder according to an embodiment of the present invention, and FIG. 4 illustrates a sectional view of a terminal holder according to an embodiment of the present invention taken along line A-A of FIG. 3.

Referring to FIGS. 2 to 4, the support plate 120 may support the fixation plate 110 with respect to the ground. For example, at least a portion of the support plate 120 may be in contact with the ground, thereby supporting the fixation plate 110 with respect to the ground. In other words, the support plate 120 may serve as a support for supporting the terminal T, attached to the fixation plate 110, to be inclined at a predetermined angle with respect to the ground.

The fixation part 130 may maintain a state in which the support plate 120 supports the fixation plate 110. The fixation part 130 may be provided in the fixation plate 110, and may be connected to the support plate 120 in a state in which the support plate 120 supports the fixation plate 110 with respect to the ground. For example, the fixation part 130 may accommodate at least a portion of the support plate 120, for example, one end 121 of the support plate 120. The fixation part 130 may include an accommodation groove 131 recessively formed at one surface of the fixation plate 110. On the other hand, unlike the drawing, the fixation part 130 may be attached to one surface of the fixation plate 110 and may include a surface in which one end of the support plate 120 is accommodated. Hereinafter, the fixation part 130 will be described based on an example wherein the fixation part 130 is recessively formed on one surface of the fixation plate 110, for convenience of description.

The fixation part 130 may include a plurality of accommodation grooves 131. The respective accommodation grooves 131 may be disposed at different positions of the fixation plate 110. In this case, the end 121 of the support plate 120 may be selectively inserted into each of the accommodation grooves 131. A mounting angle of the fixation plate 110 with respect to the ground may be changed depending upon into which one of the plurality of accommodation grooves 131 the support plate 120 is inserted. Description thereof will be given in detail below.

The connection part 140 may connect the fixation plate 110 and the support plate 120 to each other. The connection part 140 may connect the fixation plate 110 and the support plate 120 to each other to control a relative position of the fixation plate 110 and the support plate 120. For example, the connection part 140 may include an elastic body 141 that can be compressed or bent. The elastic body 141 may be include a material such as a hard steel wire, a piano wire, or stainless steel for springs. In addition, the elastic body 141 may include a plastic material and may be manufactured by a plastic injection method. However, this is only one example, and a material or manufacturing method of the elastic body 141 is not limited thereto.

The connection part 140 may assist a connection state of the support plate 120 to the fixation part 130. In other words, the connection part 140 may firmly assist a state of the support plate 120 inserted into the accommodation groove 131 in a state in which the support plate 120 supports the fixation plate 110. For example, elastic force by the elastic body 141 of the connection part 140 may work between the fixation plate 110 and the support plate 120 in a state in which the end 121 of the support plate 120 is fitted into the accommodation groove 131. That is, the elastic body 141 may provide elastic force to pull the other side of the support plate 120 in a direction of the fixation plate 110, thereby providing a bending moment such that the side of the support plate 120 rotates in a direction of the fixation plate 110. As a result, the end 121 of the support plate 120 inserted into the accommodation groove 131 is caught inside the accommodation groove 131, so that the support state of the support plate 120 with respect to the accommodation groove 131 may be firmly maintained and the support plate 120 may be prevented from being separated from the accommodation groove 131.

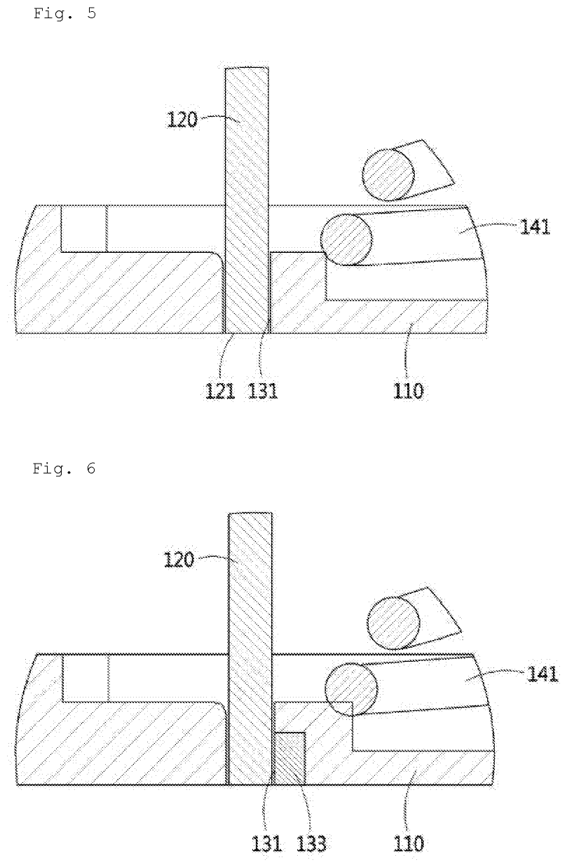

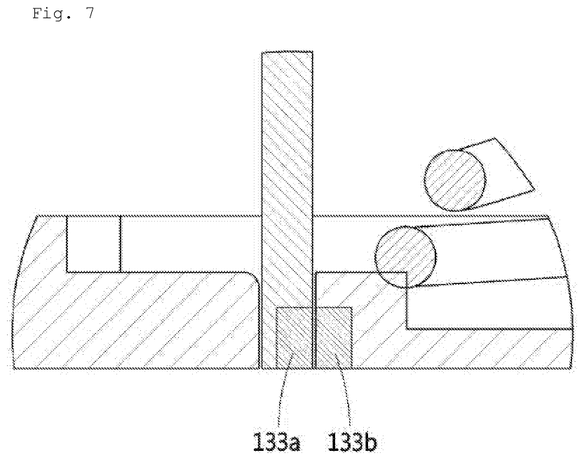

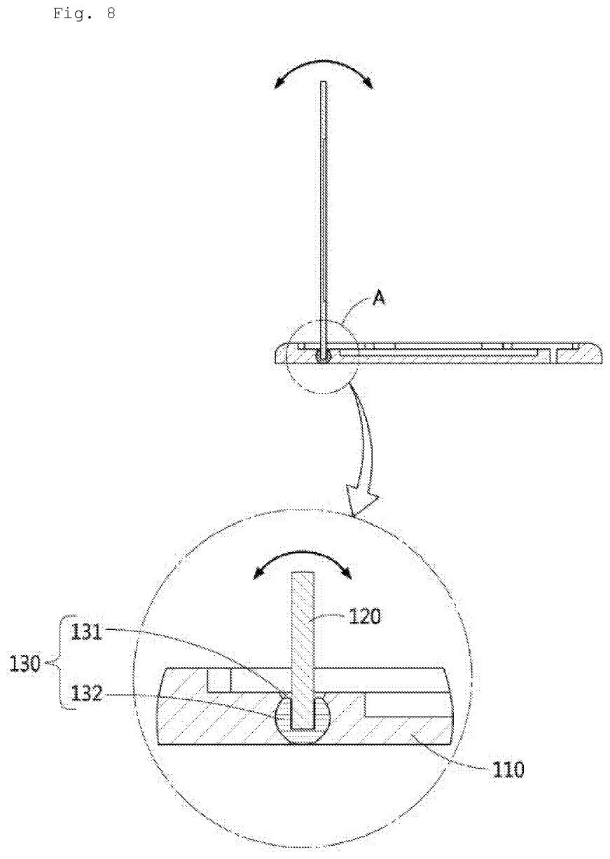

FIG. 5 is a view illustrating a fixation part according to an embodiment of the present invention in which portion B of FIG. 4 is enlarged, FIG. 6 is a view illustrating a fixation part according to an embodiment of the present invention, and FIG. 7 is a view illustrating a fixation part according to an embodiment of the present invention.

Referring to FIG. 5, the fixation part 130 may include the accommodation groove 131 recessively formed on one surface of the fixation plate 110, and the end 121 of the support plate 120 may be inserted into the accommodation groove 131. In this case, the accommodation groove 131 may be formed in a shape corresponding to the end 121 of the support plate 120. For example, the accommodation groove 131 may have a width equal to the thickness of the end 121 of the support plate 120. On the other hand, unlike the drawing, the accommodation groove 131 may have a shape wherein the width of the accommodation groove 131 is widened as recessed inward, and the width of an upper part of the accommodation groove 131 is smaller than the width of the end 121 of the support plate 120. According to such a structure, the end 121 of the support plate 120 may be fitted into the accommodation groove 131. Accordingly, by inserting the end 121 of the support plate 120 into the accommodation groove 131, the support plate 120 may be prevented from being separated from the fixation part 130 by own weight of the support plate 120, for example, from freely falling by own weight of the support plate 120. On the other hand, the end 121 of the support plate 120 may be forcibly, moderately, or loosely fitted into the accommodation groove 131 depending upon the width of the accommodation groove 131. However, this is only provided as an example, and the shape and size of the accommodation groove 131 are not limited thereto.

Referring to FIGS. 6 and 7, each of the fixation parts according to embodiments of the present invention may include a magnet body. For example, as shown in FIG. 6, the fixation part 130 may include a magnet body 133 disposed inside the accommodation groove 131, and the support plate 120 may include a magnetic body. According to such a structure, the support plate 120 is in close contact with the magnet body 133 by magnetic force of the magnet body 133 in a state in which the support plate 120 is inserted into the accommodation groove 131, so that the state of the support plate 120 inserted into the accommodation groove 131 may be firmly maintained. On the other hand, as shown in FIG. 7, the support plate 120 may include a magnet body 133a disposed at the end 121. When the end 121 of the support plate 120 is fitted into the accommodation groove 131, the support plate 120 may be in close contact with an inner surface of the accommodation groove 131 by magnetic force between magnet bodies 133a and 133b. As a result, the magnet body 133 may prevent the support plate 120 from being separated from the accommodation groove 131, thereby firmly maintaining a support state of the support plate 120 with respect to the fixation plate 110.

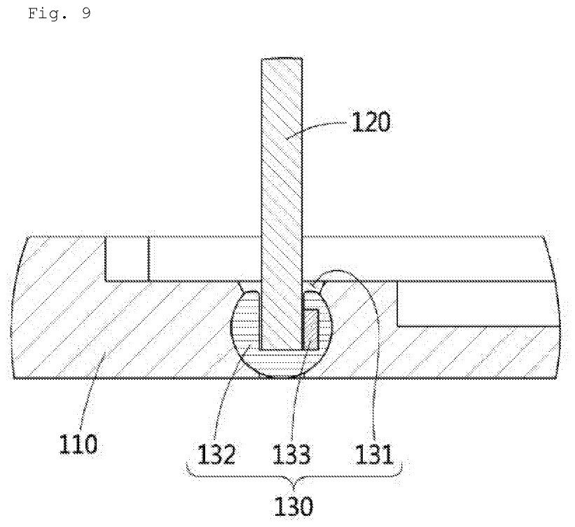

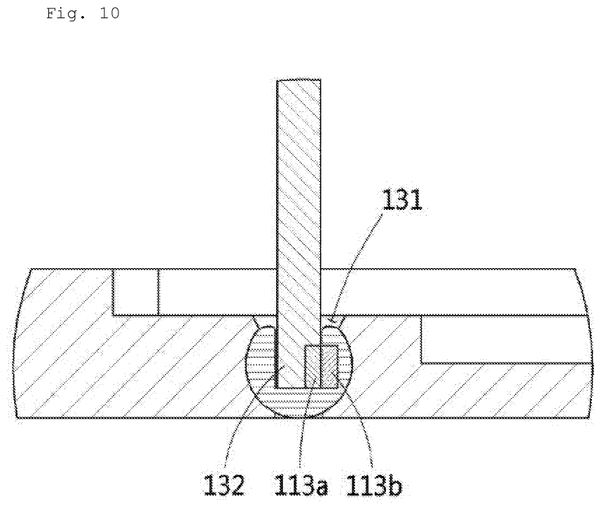

FIG. 8 is a view illustrating a fixation part including a hinge part according to an embodiment of the present invention, FIG. 9 is a view illustrating a fixation part including a hinge part according to an embodiment of the present invention, and FIG. 10 is a view illustrating a fixation part including a hinge part according to an embodiment of the present invention.

Referring to FIG. 8, the fixation part 130 may include a hinge 132 disposed in the accommodation groove 131. The hinge 132 may include an inwardly recessed concave groove such that the end 121 of the support plate 120 can be inserted thereinto. The hinge 132 may be rotated in the accommodation groove 131 such that a connection angle of the support plate 120 with respect to the fixation plate 110 can be adjusted. For example, as the hinge 132 rotates in the accommodation groove 131 in a state in which the end 121 of the support plate 120 is inserted into the concave groove of the hinge 132, an inclination between the support plate 120 and the fixation plate 110 may be adjusted. In this case, the accommodation groove 131 may have a shape inclined upward from the inside to the outside. According to such a structure, a connection angle of the support plate 120 according to rotation of the hinge 132 may be adjusted within a limited range according to an inclination shape of the accommodation groove 131. The hinge 132 may include a material having sufficient friction force to an inner surface of the accommodation groove 131, for example, a material such as rubber. Accordingly, the hinge 132 may rotate in the accommodation groove 131 only when torque of a certain value or more is applied, thereby preventing the support plate 120 connected to the fixation plate 110 from freely rotating.

Referring to FIGS. 9 and 10, the hinge 132 may include the magnet body 133. For example, as shown in FIG. 9, the hinge 132 may include the magnet body 133 disposed in the concave groove, and the support plate may include a magnetic body. Accordingly, when the support plate 120 is inserted into the concave groove of the hinge 132, the support plate 120 may be in close contact with an inner surface of the concave groove by magnetic force of the magnet body 133. On the other hand, as shown in FIG. 10, the support plate 120 may include the magnet body 133a disposed at the end 121. As a result, an insertion state of the support plate 120 with respect to the concave groove of the hinge 132 may be firmly maintained by a magnet body 133b disposed in the hinge 132, thereby preventing the support plate 120 from being separated from the hinge 132.

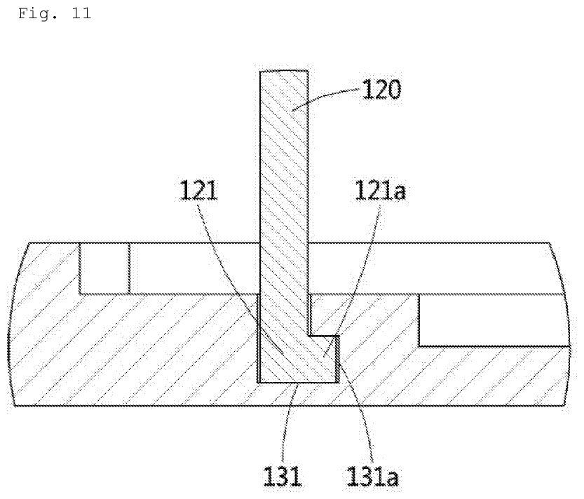

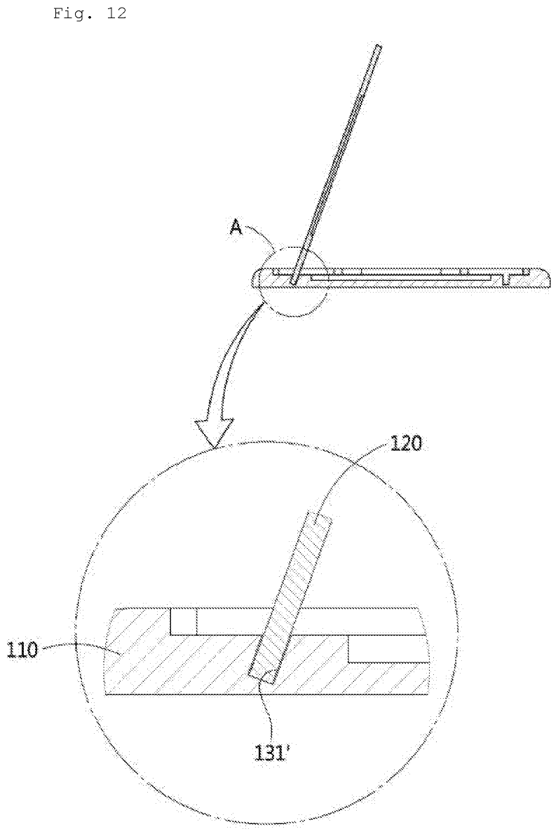

FIG. 11 is a view illustrating a fixation part according to an embodiment of the present invention.

Referring to FIG. 11, the support plate 120 according to an embodiment of the present invention may include an engagement protrusion 121a that is formed at the end 121 inserted into the accommodation groove 131. In this case, the fixation part 130 may further include the engagement groove 131a recessively formed at the accommodation groove 131 to be engaged with the engagement protrusion 121a in a state in which the end 121 is inserted into the accommodation groove 131. In other words, the engagement protrusion 121a and the engagement groove 131a may be formed to correspond to each other. For example, when the accommodation groove 131 is inserted into the end 121 of the support plate 120, the engagement protrusion 121a is seated in the engagement groove 131a, thereby preventing the support plate 120 from being separated from the fixation part 130. That is, when the engagement groove 131a is engaged with the engagement protrusion 121a, a support state of the support plate 120 with respect to the fixation plate 110 may be stably maintained. For example, as shown in FIG. 11, the engagement protrusion 121a may protrude in a shape perpendicular to the support plate 120, and the engagement groove 131a may be recessively formed to be perpendicular to a side wall of the accommodation groove 131 so as to correspond to the shape of the engagement protrusion 121a. On the other hand, unlike the drawing, the engagement protrusion 121a may be formed in an uneven groove shape at the end 121 of the support plate 120, and an inner side surface of the accommodation groove 131 may have a shape of being engaged with the groove shape. However, this is only provided as an example, and the shapes or sizes of the engagement protrusion 121a and the engagement groove 131a are not limited thereto. That is, the shapes or sizes of the engagement protrusion 121a and the engagement groove 131a may be variously changed to maintain a connection state of the support plate 120 with respect to the accommodation groove 131.

FIG. 12 is a view illustrating a fixation part according to an embodiment of the present invention.

The fixation part 130 may include an accommodation groove 131′ slantly, recessively formed at the fixation plate 110 such that the support plate 120 is slantly connected to the fixation plate 110 in a state in which the support plate 120 is connected. In other words, when the accommodation groove 131′ is recessively formed on one surface of the fixation plate 110, a recessed angle of the accommodation groove 131′ is formed so as not to be perpendicular to one surface of the fixation plate 110. Accordingly, the support plate 120 may be inserted into the accommodation groove 131′ such that the support plate 120 is inclined with the respect to the fixation plate 110. As a result, a connection angle of the support plate 120 with respect to the fixation plate 110 may be adjusted according to a recessed inclination of the accommodation groove 131′, so that a mounting angle of the terminal T with respect to the ground may be adjusted. Although the recessed inclination of the accommodation groove 131′ is formed such that the support plate 120 is inclined rightward with respect to the fixation plate 110 in the drawing, this is only provided as one example, and it is natural to form a recessed inclination of the accommodation groove 131′ such that the support plate 120 is connected to be inclined in an opposite direction. In addition, the fixation part 130 may include a plurality of accommodation grooves 131′ having different recessed angles. A connection angle of the support plate 120 with respect to the fixation plate 110 may be adjusted according to a connection state of the support plate 120 to each of the accommodation grooves 131′.

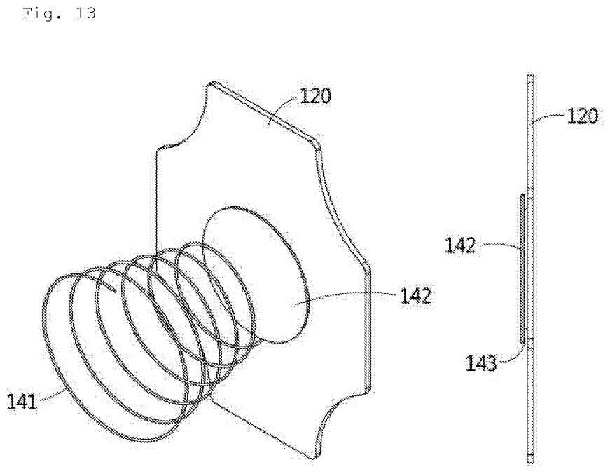

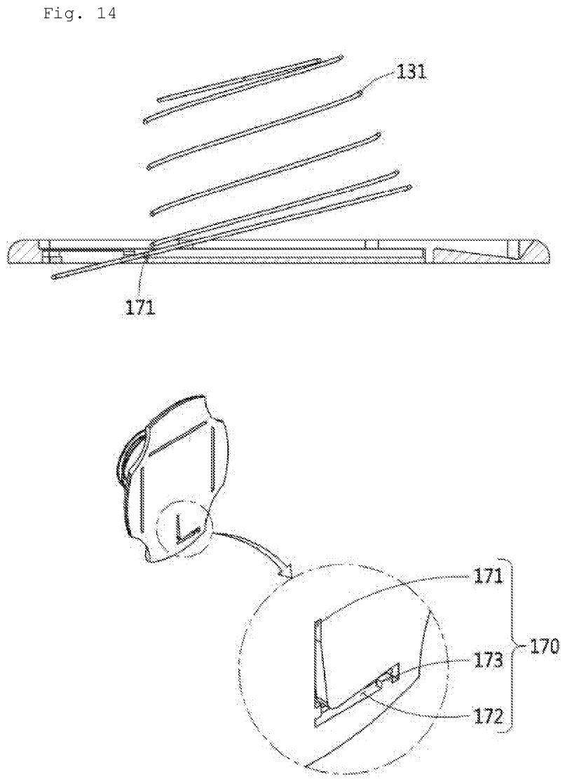

FIG. 13 is a view illustrating a connection part according to an embodiment of the present invention, and FIG. 14 is a view illustrating an elastic body-fastening part of a terminal holder according to an embodiment of the present invention.

Referring to FIGS. 13 and 14, the connection part 140 may include the elastic body 141, a protrusion 142, and the elastic body-fastening part 170.

The elastic body 141 may connect the support plate 120 and the fixation plate 110 to each other. The elastic body 141 may include a tapered spring. The tapered spring may have a shape wherein the diameter of the tapered spring gradually increases in one direction. For example, the tapered spring may have a shape wherein the diameter of the tapered spring gradually increases toward the fixation plate 110 from the support plate 120. Such a shape may be effective for the terminal holder 1 to firmly support the terminal T. Since each part of the tapered spring does not interfere with each other when the tapered spring is compressed, the tapered spring may have a minimum compression height. In other words, the tapered spring may be compressed in a nearly planar shape. Accordingly, when the terminal holder 1 is not used, the fixation plate 110 and the support plate 120 may be maximally in close contact with each other. Although the elastic body 141 is illustrated as having a circular shape in the drawing, the elastic body 141 may also have a polygonal shape, for example, a quadrangular shape.

Both sides of the elastic body 141 may be respectively connected to the support plate 120 and the fixation plate 110. For example, one side of the elastic body 141 may be connected to the support plate 120 through the protrusion 142, and the other side of the elastic body 141 may be connected to the fixation plate 110 through the elastic body-fastening part 170.

Referring to FIG. 13, the protrusion 142 may protrude from one surface of the support plate 120 such that one side of the elastic body 141 is connected to the protrusion 142. The protrusion 142 may have a shape similar to the shape of the elastic body 141. For example, when the elastic body 141 has a circular shape as a whole, the protrusion 142 may be formed in a cylindrical shape. The protrusion 142 may include a hollow formed on one surface thereof. In this case, the hollow of the protrusion 142 may be provided with a magnet body for fastening the support plate 120 and the fixation plate 110. The protrusion 142 may include an indentation 143 that is formed to be concave inward. In other words, the indentation 143 may be indented inward from a side of the protrusion 142. In this case, a portion of the elastic body 141 may be wound around the indentation 143. Since an end of the protrusion 142 has a larger diameter than the diameter of the indentation 143, a portion of the elastic body 141 wound around the indentation 143 may be prevented from being separated from the protrusion 142.

The elastic body 141 may be rotatably connected to the protrusion 142. For example, the indentation 143 may have a height greater than a cross-sectional diameter of the elastic body 141. Accordingly, a portion of the elastic body 141 wound around the indentation 143 may rotate along an outer surface of the indentation 143. As a result, the support plate 120 may rotate with respect to the fixation plate 110 through the elastic body 141. When the length of one side of the support plate 120 is longer than the length of the other side thereof, for example, when the support plate 120 has a rectangular shape, the support plate 120 may include a plurality of ends. In this case, since the support plate 120 rotates with respect to the elastic body 141, the fixation part 130 may be connected to the plurality of ends. According to such a structure, an angle at which the support plate 120 supports the fixation plate 110 with respect to the ground may be changed according to a connection state of each of the ends of the support plate 120 connected to the fixation part 130.

Referring to FIG. 14, the fixation plate 110 may be provided with the elastic body-fastening part 170 such that another end of the elastic body 141 is connected to the fixation plate 110. The elastic body-fastening part 170 may allow another end of the elastic body 141 to be selectively fastened to the fixation plate 110. The elastic body-fastening part 170 may include a through groove 171, an elastic body-fastening groove 172, and a release prevention protrusion 173.

The through groove 171 may be formed to penetrate from one surface of the fixation plate 110 in contact with the elastic body 141 to the other surface of the fixation plate 110. Accordingly, the other end of the elastic body 141 may be inserted from one surface of the fixation plate 110 into the other surface thereof through the through groove 171.

The elastic body-fastening groove 172 may be formed on the other surface of the fixation plate 110 to be connected to the through groove 171. The elastic body-fastening groove 172 may be recessively formed on the other surface of the fixation plate 110 to accommodate the other end of the elastic body 141 inserted into the through groove 171. The elastic body-fastening groove 172 may have a similar shape to the shape of the other end of the elastic body 141. For example, the other end of the elastic body 141 may be bent in a ‘¬’ shape. In this case, the elastic body-fastening groove 172 may have a shape corresponding to the shape of the other end of the elastic body 141 to accommodate the other end of the elastic body 141.

The release prevention protrusion 173 may protrude from an inner surface of the elastic body-fastening groove 172 to prevent the other end of the elastic body 141 accommodated in the elastic body-fastening groove 172 from being released. Accordingly, the other end of the elastic body 141 accommodated in the elastic body-fastening groove 172 is caught by the release prevention protrusion 173, so that a connection between the elastic body 141 and the elastic body-fastening part 170 may be prevented from being released regardless of user's intention.

As a result, the elastic body-fastening part 170 may attach/detach the elastic body 141 to/from the fixation plate 110 through a simple fastening operation without a separate adhesive member or the like for connecting the elastic body 141 to the fixation plate 110.

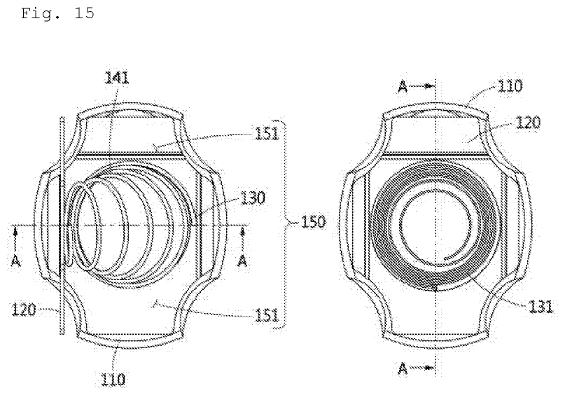

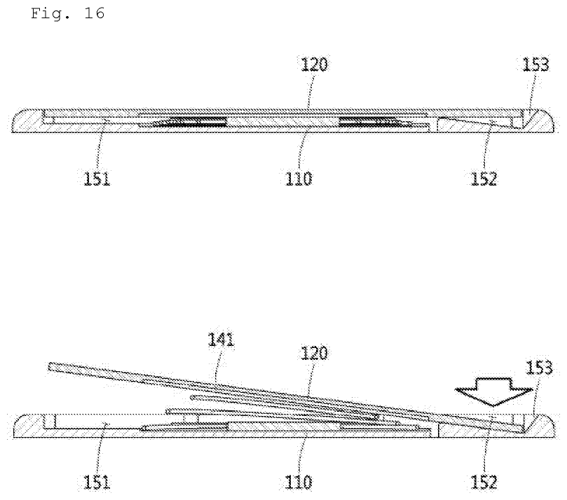

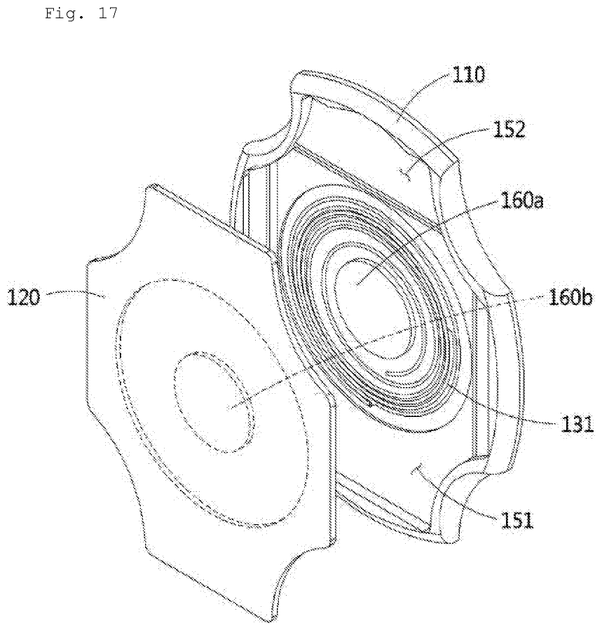

FIG. 15 is a view illustrating a fastened state of a support plate and fixation plate of a terminal holder according to an embodiment of the present invention, and FIG. 16 illustrates a side sectional view of a terminal holder including a pressing groove according to an embodiment of the present invention.

Referring to FIG. 15, the support plate 120 and the fixation plate 110 of the terminal holder 1 according to an embodiment of the present invention may be selectively fastened. For example, the support plate 120 may be fastened to the fixation plate 110 in a state in which the terminal holder 1 is not used, thereby minimizing the volume of the terminal holder 1. The terminal holder 1 may include a fastening part 150 for fastening the support plate 120 to the fixation plate 110 in a state in which the support plate 120 does not support the fixation plate 110. The fastening part 150 may include a fastening groove 151 that is inwardly, recessively formed at the fixation plate 110 to accommodate the support plate 120. The fastening groove 151 may be recessed inwardly from one surface of the fixation plate 110 to correspond to the size of the support plate 120. In this case, the support plate 120 may be fastened to the fixation plate 110 through insertion into the fastening groove 151. The fastening groove 151 may be recessively formed by a depth corresponding to the thickness of the support plate 120 such that there is no step between the fixation plate 110 and the support plate 120, in a state in which the support plate 120 is accommodated. In this case, the fixation part 130 may be provided in the fastening groove 151. For example, the accommodation groove 131 may be formed to be further recessed into the fixation plate 110 from the fastening groove 151.

The fastening groove 151 may prevent the support plate 120 from being spaced apart from the fastening groove 151 due to the connection part 140 in a state in which the support plate 120 is fastened to the fixation plate 110. For example, the fastening groove 151 may be provided with a connection accommodation groove further recessed inwardly from the fixation plate 110 to accommodate the connection part 140. The connection accommodation groove may have, for example, a recessed depth greater than the protrusion on the support plate. Since a maximum compression height of the spring is equal to or lower than the height of the protrusion when the elastic body 141 is formed in a tapered spring shape, generation of a step between the support plate 120 and the fixation plate 110 due to the protrusion 142 or the elastic body 141 may be prevented even when the support plate 120 is accommodated in the fastening groove 151.

As a result, poor appearance or user inconvenience due to a step between the fixation plate 110 and the support plate 120 may be prevented because the terminal holder 1 according to an embodiment of the present invention is fastened to the fixation plate 110 in a manner of accommodating the support plate 120 in the fastening groove 151, when not used.

Referring to FIG. 16, the terminal holder 1 may include a pressing groove 152 for releasing the fastening between the support plate 120 and the fixation plate 110. The pressing groove 152 may be formed to be slantly recessed from one side of the fastening groove 151. The pressing groove 152, for example, may be slantly recessed toward the inside of the fixation plate 110, toward the outside of the fastening groove 151. According to such a structure, the support plate 120 located on the opposite side of the pressing groove 152 is spaced apart from the fixation plate 110 by the rotation moment, i.e., the lever principle, when the pressing groove 152 is pressed in a state in which the support plate 120 is accommodated in the fastening groove 151, so that the fastened state between the fixation plate 110 and the support plate 120 may be easily released.

On the other hand, one side of the fastening groove 151 may be provided with a release groove 153 that is used when a user lifts the support plate 120 from the fastening groove 151. The release groove 153, for example, may be formed to extend from the other side of the pressing groove 152. The release groove 153 may be formed on the fixation plate 110 to generate a gap between the support plate 120 and the fixation plate 110 in a state in which the support plate 120 is accommodated in the fastening groove 151. Accordingly, a user may lift the support plate 120 from the pressing groove 152 through the release groove 153, thereby releasing the fastening between the support plate 120 and the fixation plate 110.

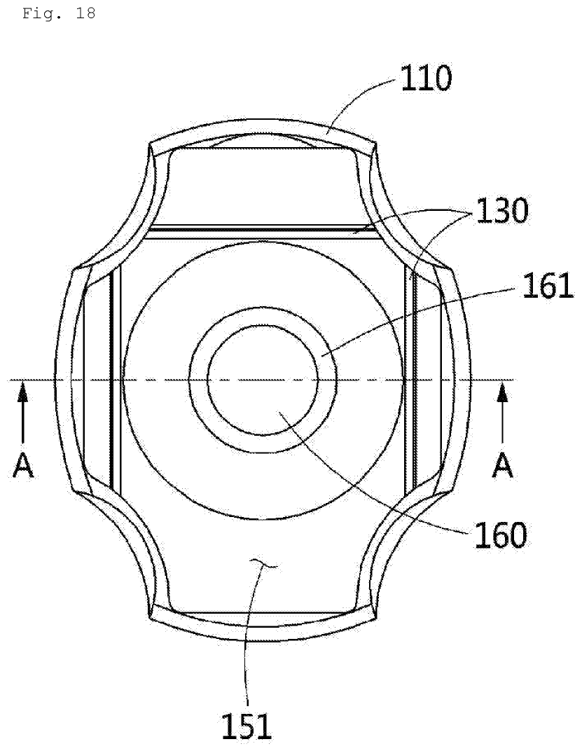

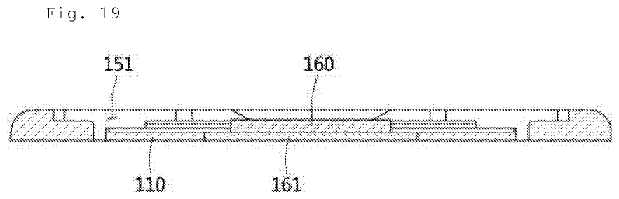

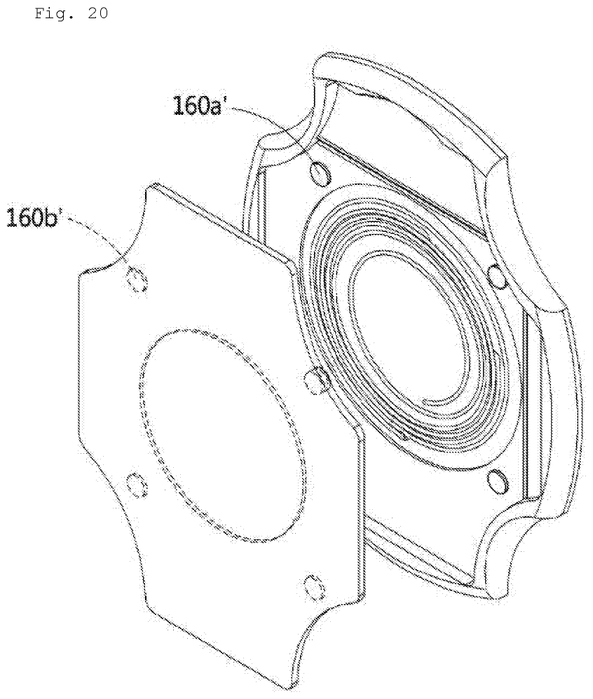

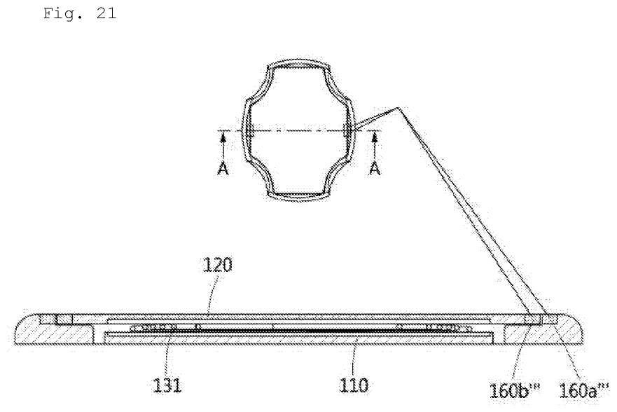

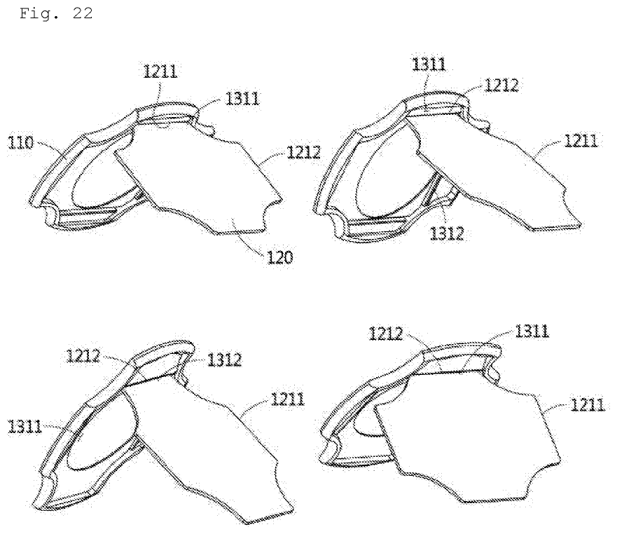

FIG. 17 illustrates a perspective view of a terminal holder including a magnet body according to an embodiment of the present invention, FIG. 18 illustrates a top view of a fixation plate including a magnet body according to an embodiment of the present invention, FIG. 19 illustrates a sectional view of a fixation plate taken along line A-A of FIG. 18, FIG. 20 illustrates a perspective view of a terminal holder including a magnet body according to an embodiment of the present invention, and FIG. 21 is a view illustrating a terminal holder including a magnet body according to an embodiment of the present invention.

Referring to FIG. 17, the terminal holder 1 according to an embodiment of the present invention may include a magnet body 160 for helping to maintain the fastened state between the fixation plate 110 and the support plate 120. The magnet body 160 may be attached to the support plate 120 or the fixation plate 110. For example, the magnet body 160 may be disposed at both the support plate 120 and the fixation plate 110. However, the arrangement of the magnet body 160 is not limited thereto, and a configuration wherein the magnet body 160 is only disposed at the fixation plate 110 and the support plate 120 includes a magnetic material, for example, an iron plate attached to a magnet body, is naturally allowed. Hereinafter, a case wherein the magnet body 160 is disposed at both the support plate 120 and the fixation plate 110 will be described in detail for convenience of description.

The magnet body 160 may be disposed, for example, at the center of each of the support plate 120 and the fixation plate 110. A magnet body disposed at the fixation plate 110 may be referred to as a first magnet body 160a, and a magnet body disposed at the support plate 120 may be referred to as a second magnet body 160b. For example, the first magnet body 160a may be disposed inside the fastening groove 151 of the fixation plate 110, and the second magnet body 160b may be disposed at the hollow formed at the protrusion 142 of the support plate 120. In this case, the first magnet body 160a and the second magnet body 160b may be disposed to be adjacent to each other in a state in which the fixation plate 110 and the support plate 120 are fastened to each other. Accordingly, when the support plate 120 is accommodated in the fastening groove 151 of the fixation plate 110, the first magnet body 160a and the second magnet body 160b generate attractive magnetic force, thereby helping to maintain the fastened state between the fixation plate 110 and the support plate 120. In other words, the magnet body 160 may prevent the support plate 120 fastened to the fixation plate 110 from being freely released from the fastening groove 151.

In this case, the support plate 120 and the fixation plate 110 may include a magnetic body 161 disposed on one side of the magnet body 160. For example, referring to FIGS. 18 and 19, the first magnet body 160a may be disposed at the center of the connection accommodation groove. In a state in which the support plate 120 is accommodated in the fastening groove 151 of the fixation plate 110, one side of the first magnet body 160a may be in contact with the second magnet body 160b. In this case, the fixation plate 110 may increase magnetic force between the first magnet body 160a and the second magnet body 160b through the magnetic body 161 disposed at the other side of the first magnet body 160a. That is, as the magnetic body 161 becomes magnetic by the magnet body 160, magnetic force between the magnetic bodies 160a and 160b may increase. Although the case wherein the magnetic body 161 is attached to the fixation plate 110 is illustrated in the drawing, this is only provided as an example and a configuration wherein the magnetic body 161 is attached to the support plate 120 is possible. In addition, the support plate 120 itself becomes magnetic by the magnet body 160 when the support plate 120 is formed of a magnetic body made of a metal material, thereby strengthening the magnetism between the magnet bodies 160.

Referring to FIG. 20, each of the support plate 120 and the fixation plate 110 may be provided with a plurality of magnet bodies 160′. For example, a plurality of first magnet bodies 160a′ may be disposed, with respect to the elastic body, on the fixation plate 110, and a plurality of second magnet bodies 160b′ may be disposed on the support plate 120 to correspond to the first magnet bodies 160a′ Referring to FIG. 21, second magnet bodies 160b″ may be provided at both ends of the support plate 120, and first magnet bodies 160a″ having a polarity opposite to the second magnet bodies 160b″ may be provided at an inner wall of the fastening groove of the fixation plate 110. According to such a structure, the first magnet bodies 160a″ and the second magnet bodies 160b″ are disposed to be adjacent to each other and attract each other due to magnetic force in a state in which the support plate 120 is seated in the fastening groove 151, so that the support plate 120 may be prevented from being released from the fastening groove 151 of the fixation plate 110. Accordingly, the fastened state between the support plate 120 and the fixation plate 110 may be maintained.

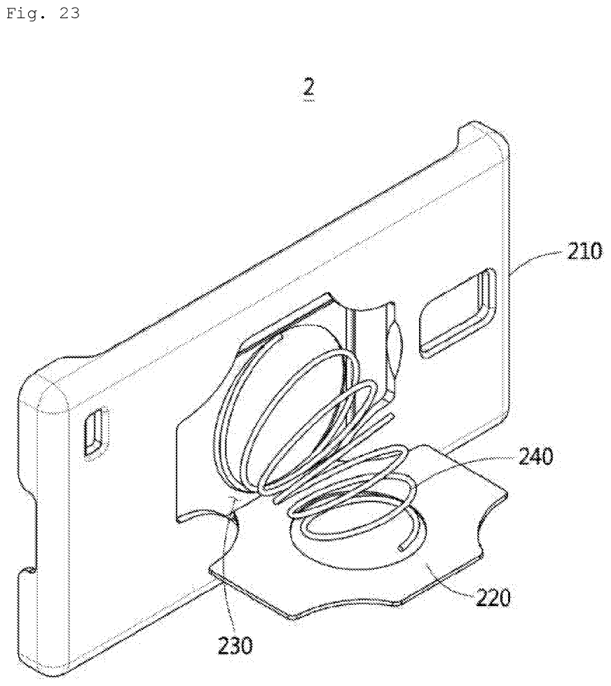

FIG. 22 illustrates a state diagram of use of a terminal holder according to an embodiment of the present invention.

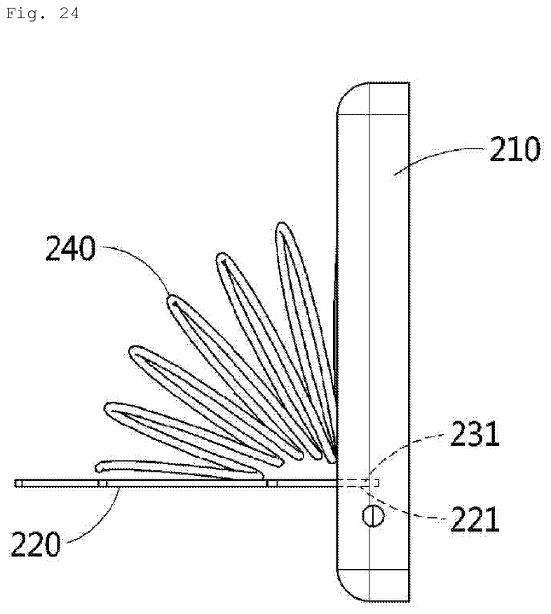

Referring to FIG. 22, a terminal holder 1 may mount the terminal T at various angles with respect to the ground. For example, the support plate 120 may include a plurality of ends 1211 and 1212, and the fixation part 130 may include a plurality of accommodation grooves 1311 and 1312 disposed at various positions of the fixation plate 110. When the support plate 120 and the fixation plate 110 have a shape wherein the length of one side of each thereof is different from the length of the other side thereof, for example, a rectangular shape, an angle at which the support plate 120 mounts the fixation plate 110 with respect to the ground may be adjusted according to a connection state between the accommodation grooves 1311 and 1312 and the ends 1211 and 1212. Since the support plate 120 may rotate with respect to the fixation plate 110 when the support plate 120 and the fixation plate 110 are connected to each other through the connection part, each of the ends 1211 and 1212 of the support plate 120 may be selectively connected to each of the accommodation grooves 1311 and 1312. As a result, an inclination angle of the terminal holder 1 with respect to the ground may be adjusted as desired by the user FIG. 23 illustrates a perspective view of a terminal case according to an embodiment of the present invention, and FIG. 24 illustrates a side view of a terminal case according to an embodiment of the present invention.

Components including the same functions as the components included in the aforementioned embodiment will be described using the same names. Unless stated to the contrary, the description of the aforementioned embodiment may be applied to other embodiments, and detailed descriptions thereof will be omitted.

Referring to FIGS. 22 and 23, a terminal case 2 according to an embodiment of the present invention may include a terminal cover 210 for covering at least a portion of a terminal; a support plate 220 for supporting the terminal cover 210 with respect to the ground; a connection part 240 for connecting the terminal cover 210 and the support plate 220 to each other; a fixation part 230 for maintaining the state of the support plate 220 supporting the terminal cover 210; and a magnet body for assisting connection and fastened states between the terminal cover 210 and the support plate 220.

The terminal cover 210 may be formed to correspond to the size of a terminal. Since the terminal cover 210 surrounds at least a portion of a terminal whereas the fixation plate 110 described above is attached to a terminal, the terminal cover 210 may be selectively attached to a terminal. On the other hand, since the terminal cover 210 is formed integrally with a terminal, it may be implemented in the shape of the terminal.

The terminal cover 210 may include a support plate-accommodating part for fastening the support plate 220. In this case, the support plate-accommodating part may be formed to have a size corresponding to the size of the support plate 220, thereby preventing the generation of a gap between the support plate-accommodating part and the support plate 220 when the support plate 220 is fastened to the terminal cover 210. The support plate-accommodating part may be recessed inwardly by a depth corresponding to the thickness to the support plate 220 to prevent the generation of a gap between the support plate 220 and the terminal cover 210 in a state in which the support plate is fastened to the terminal cover 210. In this case, the support plate-accommodating part may be provided with a connection accommodation part for accommodating the connection part 240.

The fixation part 230 may be formed at the support plate-accommodating part. The fixation part 230 may include an accommodation groove recessively formed in an inner direction of the terminal cover 210. One end of the support plate 220 may be inserted into the accommodation groove.

In summary, the terminal case 2 according to an embodiment of the present invention may mount a terminal with respect to the ground depending upon a connection state of the terminal cover 210 and the support plate 220. In addition, the support plate 220 is fastened to the terminal cover 210 when the terminal case 2 is not used, so that the volume of the terminal case 2 may be minimized and easily stored by a user.

Although the present disclosure has been described with reference to limited embodiments and drawings, it should be understood by those skilled in the art that various changes and modifications may be made therein. For example, the described techniques may be performed in a different order than the described methods, and/or components of the described structures, devices, etc., may be coupled or combined in a manner that is different from the described method, or appropriate results may be achieved even if replaced by other components or equivalents.

Therefore, other embodiments, other examples, and equivalents to the claims are within the scope of the following claims.

1. A terminal holder, comprising:
a holding plate configured to be attachable to a terminal; and
a fixation part provided in the holding plate; and
a support plate selectively connected to the fixation part and configured to support the holding plate with respect to the ground in a state of being connected to the fixation part.

2. The terminal holder according to claim 1, wherein the fixation part comprises an accommodation groove recessively formed at one surface of the holding plate to accommodate at least a portion of the support plate.

3. The terminal holder according to claim 2, wherein one end of the support plate is inserted into the accommodation groove.

4. The terminal holder according to claim 3, further comprising a connection part for connecting the holding plate and the support plate to each other and helping maintain a connection state of the support plate to the accommodation groove.

5. The terminal holder according to claim 4, wherein the connection part comprises an elastic body for providing elastic force to pull another side of the support plate in a direction of the holding plate in a state in which one end of the support plate is inserted into the accommodation groove.

6. The terminal holder according to claim 5, wherein the connection part comprises a protrusion provided at one surface of the support plate to be connected to one side of the elastic body.

7. The terminal holder according to claim 6, wherein the protrusion comprises an indentation formed to be concave inward, and a portion of the elastic body is wound around the indentation.

8. The terminal holder according to claim 6, wherein the support plate is rotatable with respect to the elastic body to adjust a support angle to the holding plate.

9. The terminal holder according to claim 5, wherein:
the connection part further comprises an elastic body-fastening part provided in the holding plate such that another side of the elastic body is connected to the holding plate; and
the elastic body-fastening part comprises:
a through groove configured to penetrate from one surface of the holding plate to another surface thereof;
an elastic body-fastening groove formed at another surface of the holding plate to accommodate another end of the elastic body inserted in the through groove; and
a release prevention protrusion formed at the elastic body-fastening groove to prevent another side of the elastic body from being released.

10. The terminal holder according to claim 3, wherein one end of the support plate is fitted into the accommodation groove.

11. The terminal holder according to claim 2, wherein the accommodation groove is slantingly recessed such that the support plate is inclined with respect to the holding plate in a state in which the support plate is inserted into the accommodation groove.

12. The terminal holder according to claim 2, wherein the support plate comprises an engagement protrusion formed at one end thereof, and the fixation part further comprises an engagement groove formed to be engaged with the engagement protrusion in a state in which the end of the support plate is inserted into the accommodation groove.

13. The terminal holder according to claim 2, wherein the fixation part further comprises a hinge which is disposed in the accommodation groove and into which one end of the support plate is inserted, wherein the hinge is rotatable in the accommodation groove such that a connection angle of the support plate with respect to the holding plate is adjustable.

14. The terminal holder according to claim 10, further comprising a magnet body provided in the accommodation groove to maintain a connection state between the fixation part and the support plate.

15. The terminal holder according to claim 2, wherein the fixation part comprises a plurality of accommodation grooves into which the support plate is selectively inserted, and a mounting angle of the holding plate with respect to the ground is adjusted depending on insertion of the support plate into the accommodation grooves.

16. The terminal holder according to claim 1, further comprising a fastening part for fastening the support plate to the holding plate in a state in which the support plate does not support the holding plate.

17. The terminal holder according to claim 16, wherein the fastening part comprises a fastening groove inwardly, recessively formed at the holding plate to correspond a size of the support plate.

18. The terminal holder according to claim 17, wherein the fastening part further comprises a pressing groove slantly recessed on one side of the fastening groove, and a fastened state between the holding plate and the support plate is released when the pressing groove is pressed in a state in which the support plate is accommodated in the fastening groove.

19. The terminal holder according to claim 17, wherein the fastening part further comprises a release groove extended from one side of the fastening groove such that a gap is generated between the support plate and the fixation plate in a state in which the support plate is accommodated in the fastening groove.

20. The terminal holder according to claim 16, further comprising a magnet body attached to the support plate or the fixation plate and configured to help maintain a fastened state of the support plate to the holding plate.

21. The terminal holder according to claim 20, further comprising a magnetic body comprised in the support plate or the fixation plate to be disposed on one side of the magnet body.

22. A terminal case, comprising:
a terminal cover for covering at least a portion of a terminal;
a support plate for supporting the terminal cover with respect to the ground;
a connection part for connecting the terminal cover and the support plate to each other; and
a fixation part formed one side of the terminal cover and configured to accommodate a portion of the support plate to maintain a state of the support plate supporting the terminal cover.

23. The terminal case according to claim 22, wherein the terminal cover comprises a support plate-accommodating part for fastening the support plate, wherein the support plate-accommodating part is recessed inwardly by a size corresponding to the support plate.

24. The terminal holder according to claim 11, further comprising a magnet body provided in the accommodation groove to maintain a connection state between the fixation part and the support plate.

25. The terminal holder according to claim 12, further comprising a magnet body provided in the accommodation groove to maintain a connection state between the fixation part and the support plate.

26. The terminal holder according to claim 13, further comprising a magnet body provided in the accommodation groove to maintain a connection state between the fixation part and the support plate.

27. The terminal holder according to claim 14, wherein the fixation part comprises a plurality of accommodation grooves into which the support plate is selectively inserted, and a mounting angle of the holding plate with respect to the ground is adjusted depending on insertion of the support plate into the accommodation grooves.
